(19) United States
(12) Patent Application Publication
(10) Pub. No.: US 2006/0247811 A1
(43) Pub. Date: Nov. 2, 2006

(54) Batch processing control of volume events in a digital amplifier environment

(75) Inventors: David Edward Zaucha, Carrollton, TX (US); Josey George Angilivelil, Sachse, TX (US); Anker Bjorn-Josefsen, Lynge (DK); Thomas Holms Hansen, Vaerlose (DK); Douglas Allen Roberson, Rockwall, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/120,210

(22) Filed: May 2, 2005

(51) Int. Cl. G06F 17/00

(52) U.S. Cl. 700/94

(57) ABSTRACT

A digital audio-visual receiver (10) with improved digital control of audio volume is disclosed. Upon receipt of a user volume command, via a front panel (25) or a remote control and infrared receiver (27), sequential logic (36) in a volume command processor (35) in a PWM audio processor (20) of the receiver (10) initiates a timer (38), which measures or counts a selected interval. If additional volume commands are received during the interval, sequential logic (36) resets and restarts the timer (38). Upon the timer (38) interval elapsing without another volume command, the volume command processor (35) generates a ramping volume output signal to reach the volume level of the last received volume command over a selected time duration. Audible artifacts during changes in audio volume are thus avoided.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of digital audio systems, and is more specifically directed to audio volume control in such digital audio systems.

In recent years, digital signal processing techniques have become prevalent in many electronic systems. Tremendous increases in the switching speed of digital circuits have enabled digital signal processing to replace, in large part, analog circuits in many applications. For example, the sampling rates of modern digital signal processing are sufficiently fast that digital techniques have become widely implemented in audio electronic applications. These digital audio signal processing techniques now extend even to the driving of the audio output amplifiers.

As a result of these advances in digital audio amplifiers, and advances in digital signal processing generally, audio-visual receivers can now be realized nearly entirely in the digital domain. To the extent that audio signals remain to be processed, these digital receivers can convert any received analog audio input signals to digital form, and process the corresponding signals in a similar manner as the other digital audio signals in the system.

It has been observed, however, that the manner in which conventional digital receivers operate can insert audible artifacts into audible output. One source of such audible artifacts has been observed, according to this invention, to be discontinuities in the receipt and processing of volume control commands.

In conventional digital audio receivers, changes in volume to be applied to one or more audio channels are effected by way of a sequence of digital control commands and signals that are issued and processed within the system, in response to the user input. However, because of the limitations of the electromechanical man-machine interface (e.g., knobs or sliders on the receiver front panel), this sequence is not a steady series of monotonically increasing or decreasing values, but rather contains periodic or intermittent discontinuities in the desired volume change to be performed by the receiver.

For example, the system controller in a typical conventional receiver periodically polls the position of a front panel actuator, such as a knob or slider, to read the current desired audio volume setting. Upon detecting changes in position of the actuator as the human user changes the desired audio volume, the system controller will start to adjust the audio volume to the desired level by applying a series of incremental adjustments to the audio amplifier. In a typical digital audio amplifier system, these adjustments are communicated to preamplifier control circuitry by way of digital volume level commands communicated over a digital serial interface such as of the I²C or SPI type. The volume level commands are received by the preamplifier, which translates these digital volume level commands into audio gain adjustments. As known in the art, the available signal bandwidth of such digital serial interfaces can be quite limited, causing delay in the transmission of the digital volume level settings. As the preamplifier receives and performs the audio adjustments, the system controller continues to poll the actuator position, so that new volume commands may be received by the preamplifier before the adjustment is complete. Many conventional systems handle the receipt of new volume level commands by stopping the current volume adjustment process and then restarting the process to adjust the volume to the newest desired level. In other conventional systems, the system controller simply ignores new volume level commands until the pending volume adjustment process is complete. Either of these conventional approaches thus produces discontinuities in the rate at which the audio volume is adjusted. The limited bandwidth of the serial digital interface can exacerbate these discontinuities by further delaying the transmission of volume level commands in the system. It has been observed that these discontinuities during volume changes are reflected in audible artifacts in the audio output, which are of course unpleasant and undesirable.

An example of the effects of this operation, in a conventional digital receiver system, is illustrated in FIG. 1, by way of plots 2 and 4 of the input and output volume levels, respectively, over time. As shown in the Figure, prior to time t₀, a relatively low steady-state volume level L₁ is being output by the conventional digital receiver. At time t₀, the human user has begun increasing the volume toward an ultimate volume level L₂ as shown relative to plot 2, for example by turning the volume knob on the front panel. The changes in position of the knob are interpreted by the receiver as discrete polling events with changing actuator position, as discussed above. In this example, beginning from time t₀, the digital receiver processes each discrete volume increase command, and adjusts the output volume level accordingly, as shown by plot 4. But because of the discontinuities in the receipt and processing of the human actuation of the volume adjustment, as described above, these input commands effect a sequence of volume commands that have an irregular rate of audio volume change over time. This irregular rate of change is evident in FIG. 1 from the constant volume intervals between the ramping output level intervals in plot 4. And the irregular manner in which the human user inputs the desired increasing volume level, as indicated by plot 2, is also reflected in irregularities in the rate of output volume level shown in plot 4.

As well known in the art, these irregularities in audio volume control and the resulting instantaneous changes in audio volume generate audible artifacts beyond the volume change itself. These audible artifacts, including “zipper” noise, “clicks”, “pops”, and the like, are annoying to the user and therefore undesirable.

Another type of discontinuity appears in conventional multiple channel audio receivers, due to differences in the rates at which individual channel information is read by the system controller. In the multiple channel context, this interruption of volume control execution can be heard in the “staggering” of volume changes among channels, with the volume for one channel changed by the receiver before the desired volume changes are applied to other channels. The staggering in audio volume control can be evident to the user as an out-of-balance sound, in which one or more channels are louder than one or more other channels.

As known in the art, it is possible to design digital filters of sufficient complexity to realize any arbitrary frequency response characteristic. It is therefore possible to derive complex low pass filters, within the digital processing channels, that would smooth the digital transitions from one volume level to another and thus eliminate such audible artifacts as clicks, pops, and zipper noise caused by the interruption and resumption of volume control commands, channels. However, the filter complexity required to achieve this effect are computationally complicated, and thus costly to implement into digital receiver equipment.

In a more general sense, digital signal processors in other applications also suffer from the effects of discontinuities in volume control commands. For example, users or automated controllers may apply volume (or gain) control in the receipt, encoding, and recording of audio input signals, for example in connection with digital audio-visual recording. These control operations in such encoding equipment may produce a repeating pattern of regular discontinuities, resulting in the encoding and recording of audible artifacts along with the desired audio and video content.

### BRIEF SUMMARY OF THE INVENTION

It is therefore an object of this invention to provide a digital audio processor in which the periodic sampling of irregular volume control command sequences do not result in audible artifacts in the processor output.

It is a further object of this invention to provide such a processor and system that efficiently effects excellent digital control of audio volume while avoiding audible artifacts and noise during volume control.

It is a further object of this invention to provide such a processor that can also process input audio signals, such as encoding and recording of such input audio, with recording volume changes smoothly applied to the encoded output without audible artifacts.

Other objects and advantages of this invention will be apparent to those of ordinary skill in the art having reference to the following specification together with its drawings.

The present invention may be implemented into a digital audio, or audio-visual, receiver. A volume command processor in the receiver receives volume change inputs, for example from a human user via a system controller, and includes a timer that measures a selected time duration, but that resets upon receiving another user audio volume command. Those audio volume commands that have been received since a last instance of the timer reaching its selected time duration are queued into a “batch” command. Upon the timer reaching the selected time duration, the queued volume commands are processed in a linear ramp fashion, over a fixed duration.

### BRIEF DESCRIPTION OF THE SEVERAL VIEWS OF THE DRAWING

FIG. 1 is a plot of audio volume changes effected over time by a conventional digital audio receiver.

FIG. 2 is an electrical diagram, in block form, of a digital audio-visual receiver constructed according to the preferred embodiment of the invention.

FIG. 3 is an electrical diagram, in block form, of a portion of the system controller in the receiver of FIG. 2, constructed according to the preferred embodiment of the invention.

FIG. 4 is a state diagram illustrating the operation of the system controller of FIG. 3, according to the preferred embodiment of the invention.

FIG. 5 is a flow diagram illustrating the operation of the system controller of FIG. 3 in effecting ramped volume changes, according to the preferred embodiment of the invention.

FIG. 6 is a plot of audio volume changes effected over time by the receiver of FIG. 2, constructed according to the preferred embodiment of the invention.

### DETAILED DESCRIPTION OF THE INVENTION

The present invention will be described in connection with its preferred embodiment, namely as implemented into a digital audio-visual receiver, because it is contemplated that this invention is especially beneficial when utilized in such an application. However, it is contemplated that other applications may also benefit from this invention. For example, it is contemplated that this invention may be used in connection with any digital signal processor function that processes signals and in which volume control commands may be executed; one implementation of such a function is a digital signal processor that is encoding incoming audio signals for digital storing or transmission. Other applications may similarly benefit from this invention. Accordingly, it is to be understood that the following description is provided by way of example only, and is not intended to limit the true scope of this invention as claimed.

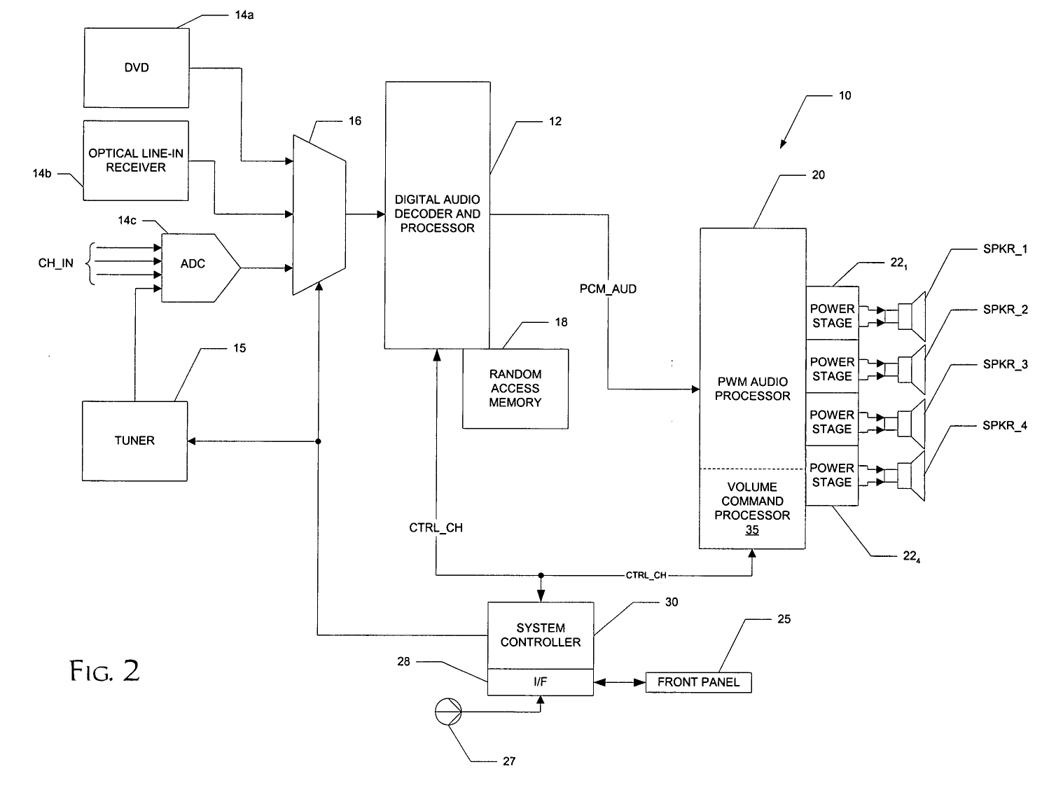

Referring now to FIG. 2, the construction of audio processing circuitry in digital audio-visual receiver 10 according to the preferred embodiment of the invention will now be described. The video data paths in digital audio-visual receiver 10 are not shown, for the sake of clarity in this description. In the example of receiver 10, multiple sources of audio signals are available to receiver 10, and may be processed into output audio by digital audio decoder and processor 12. Multiplexer 16 receives digital audio from DVD controller 14a, such audio corresponding to audio content in conjunction with DVD movies, or audio CD output played on the DVD player (not shown) to which receiver 10 is connected. Optical line-in receiver 14b provides digital audio, for example from satellite or cable television sources, to another input of multiplexer 16. Analog-to-digital converter (ADC) 14c converts analog stereo signals from analog line-in inputs CH_IN and from tuner 15 to a digital datastream, and provides this datastream to another input of multiplexer 16. Multiplexer 16 chooses from among these inputs, and inputs from other sources if available, for application to digital audio decoder and processor 12, under the control of system controller 30. The selection of audio source effected by multiplexer 16 is under user control; in this regard, system controller receives direct selection inputs from front panel switches 25 of receiver 10, or infrared remote control signals via infrared receiver 27, both communicating with system controller 30 via interface circuitry 28.

Digital audio decoder and processor 12 is a conventional integrated circuit, or integrated circuit core, for decoding and digitally processing the digital audio signals from multiplexer 16. Alternatively, digital audio decoder and processor 12 may be implemented as part of a larger-scale integrated circuit for decoding and processing digital video and audio signals, an example of which is an MPEG-2 decoder implemented using a digital signal processor such as from the DA610 class of digital signal processors available from Texas Instruments Incorporated. In either case, functions performed by digital audio decoder and processor 12, in combination with its random access memory 18, include decoding of the incoming digital data, applying the various digital audio data to corresponding channels supported by receiver 10, applying digital filters as desired, and formatting the digital audio data into a pulse-code-modulated (PCM) format, in this example. The PCM signals for each channel are then forwarded to pulse-width-modulation (PWM) audio processor 20.

PWM audio processor 20 is a conventional device for converting the PCM digital audio signals at its inputs to corresponding pulse-width-modulated (PWM) signals to drive the corresponding channel speakers SPKR, to an audio volume for each channel corresponding to digital commands communicated from system controller 30 over digital serial interface CTRL_CH which is preferably a relatively low-bandwidth digital serial interface such as of the well-known I²C or SPI types. PWM audio processor 20 preferably includes a preamplifier stage, which amplifies the incoming PCM signal to a desired level; according to this preferred embodiment of the invention, control of the audio volume is effected at this preamplifier stage. Alternatively, of course, volume control may be applied to later amplification stages within PWM audio processor 20, as known in the art. In either case, PWM audio processor 20 includes volume command processor 35, which receives the digital commands from system controller over digital serial interface CTRL_CH, and controls the adjustment of the audio volume for each channel according to the preferred embodiment of the invention, as will be described in further detail below.

PWM audio processor 20 also preferably includes conventional circuitry for performing the conventional functions of parametric speaker equalization or “voicing”, implementation of graphic equalizer presets, treble and bass adjustment, and precision soft volume control on the audio signal being processed for its channel. Other digital functions that can be performed by PWM audio processor 20 include loudness compensation to boost bass frequencies when the output for the channel is low, dynamic range compression, background noise floor compensation or noise squelch, center or sub-woofer channel synthesis, programmable dither, peak limiting and clipping, and other digital filter processing. These functions are typically performed by the application of biquad, or second-order IIR, digital filters in a cascade arrangement. A preferred example of this and other processing performed by PWM audio processor 20 is described in copending application Ser. No. 10/988,268, filed Nov. 12, 2004, and entitled “On-the-Fly Introduction of Interchannel Delay in a Pulse-Width-Modulation Amplifier”.

In this example, PWM audio processor 20 processes digital audio signals to produce PWM output signals for four channels. For each of these four channels, PWM audio processor 20 produces separate PWM control signals that are applied to a corresponding power stage 22₁ through 22₄, each of which drives a respective one of loudspeakers SPKR_1 through SPKR_4, as shown in FIG. 2. Of course, more or fewer audio channels may be driven by receiver 10. In a simple stereo arrangement, only two channels may be processed; alternatively, as many as eight audio channels are now commonly handled by digital audio-visual receivers such as receiver 10. The number of channels supported and utilized by receiver 10 is a matter of choice for the designer and the user.

In FIG. 2, digital audio decoder and processor 12, PWM audio processor 20, and memory 18 are illustrated as separate functions. It is contemplated, however, that these digital functions may be readily integrated into a single integrated circuit, and indeed such integration is preferred for the benefits of reduced manufacturing cost, improved device matching, and the like. Of course, these functions may be realized in separate integrated circuits in the alternative, as appropriate.

As mentioned above, system controller 30 provides audio source selection signals to multiplexer 16, and channel volume control signals to volume command processor 35 in PWM audio processor 20. System controller 30 also provides other control signals throughout receiver 10, including channel selection control to tuner 16 in response to user inputs received via front panel 25 or infrared receiver 27, and operational control signals applied to digital audio decoder and processor 12, also over a digital serial interface CTRL_CH in this example. As mentioned above, digital serial interface CTRL_CH may be implemented according to conventional control interface approaches, including the well-known I²C and SPI interface techniques. In any event, according to the preferred embodiment of this invention, volume command processor 35 includes circuitry for smoothly controlling changes in audio volume to be applied by PWM audio processor 20 to each of its audio channels, as will now be described in further detail.

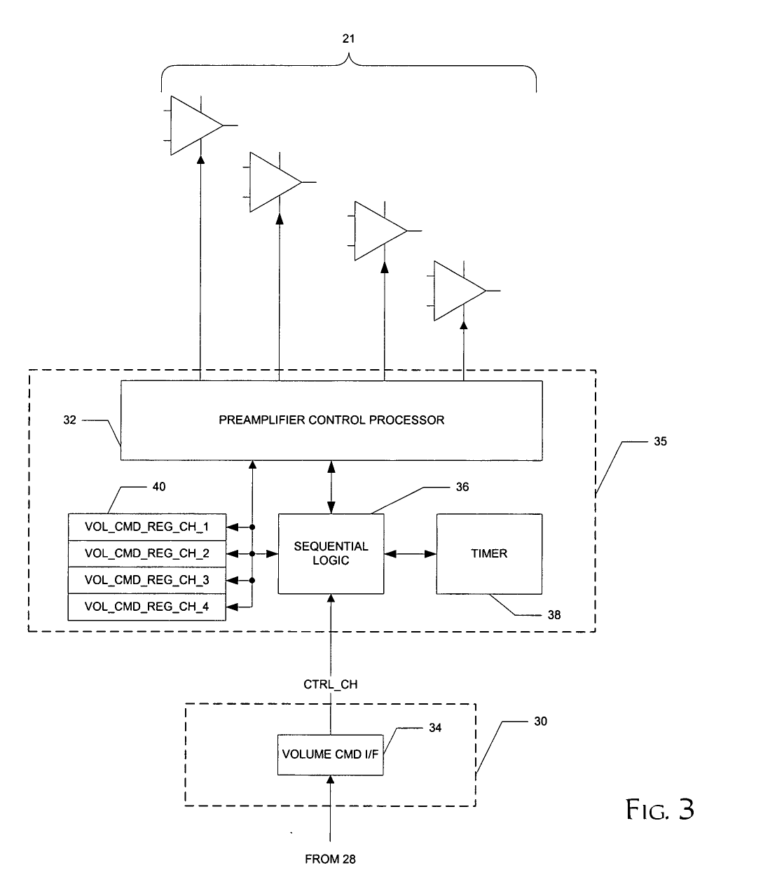

FIG. 3 illustrates the construction of part of volume command processor 35 in combination with part of system controller 30. It is contemplated that this construction of volume command processor 35 may be realized by way of any one of a number of conventional approaches, including programmable general purpose logic, custom logic, standard logic cells, or semi-custom logic. Accordingly, this construction of volume command processor 35 will be described by way of its functional blocks, with those skilled in the art having reference to this specification being readily able to realize these functions using the optimal circuit and architecture for the particular implementation. It is also contemplated that volume command processor 35 will have additional functions besides the audio volume function illustrated in FIG. 3 and described herein, such functions including source selection and control, parameters to be applied to the digital processing of the audio signals, selection of the desired radio station for tuning by tuner 16, and the like.

As shown in FIG. 3, volume command interface 34 in system controller 30 receives volume commands from interface 28, which in turn receives user volume commands from the human user via knobs or sliders on front panel 25, or via a remote control and infrared receiver 27, or the like. Volume command interface 34 has an output connected to volume command processor 35 of PWM audio processor 20, to which it passes the volume command inputs in a suitable signal format. According to this preferred embodiment of the invention, volume command interface 34 passes these inputs to volume command processor 35 over serial digital interface CTRL_CH, which may be an I²C or SPI type of serial digital interface channel.

Within volume command processor 35, sequential logic 36 receives the inputs from volume command interface 34 over digital serial interface CTRL_CH. Sequential logic 36 is connected to a storage resource for the volume commands that are received via interface 34 for each of the audio channels. According to this embodiment of the invention, receiver 10 processes volume commands individually for each channel, on a channel-by-channel basis, as will be described below. In the example of FIG. 3, this storage resource is arranged as volume command registers 49, with one register 49 associated with each of the (four) channels supported by receiver 10. Also according to this embodiment of the invention, each register 49 stores only the most recent volume command for its channel; previously stored volume commands are not used, and can be discarded.

According to this preferred embodiment of the invention, volume command processor 35 includes timer 38. As will be evident from the following description, timer 38 measures a selected time duration, according to which the volume commands are processed by sequential logic 36. This time duration measured by timer 38 may be programmed by way of a control register (not shown) or other interface via commands from system controller 30; alternatively, this duration may be hardwired or otherwise pre-set at timer 38. The specific interval for timer 38 may be selected to considering the desired volume smoothness and tolerable latency in the system, and therefore may vary widely in varying applications. For example, it is contemplated that an interval of on the order of 5 msec will be suitable in typical applications.

Preamplifier control processor 32 generates and applies volume control signals, in response to control signals issued by sequential logic 36. In this example, with four channels being processed by receiver 10, volume command processor 32 issues four separate control signals, on lines VOL_CH_1 through VOL_CH_4, to PWM audio processor 20 for these four channels. Of course, more or fewer volume control signals are issued by preamplifier control processor 32, depending on the number of channels supported by receiver 10. Preamplifier control processor 32 may be constructed as combinational or sequential logic, or programmable logic, for performing the functions described herein. It is contemplated that those skilled in the art having reference to this specification will be readily able to implement preamplifier control processor 32 in an architecture and realization suitable for specific applications, without undue experimentation.

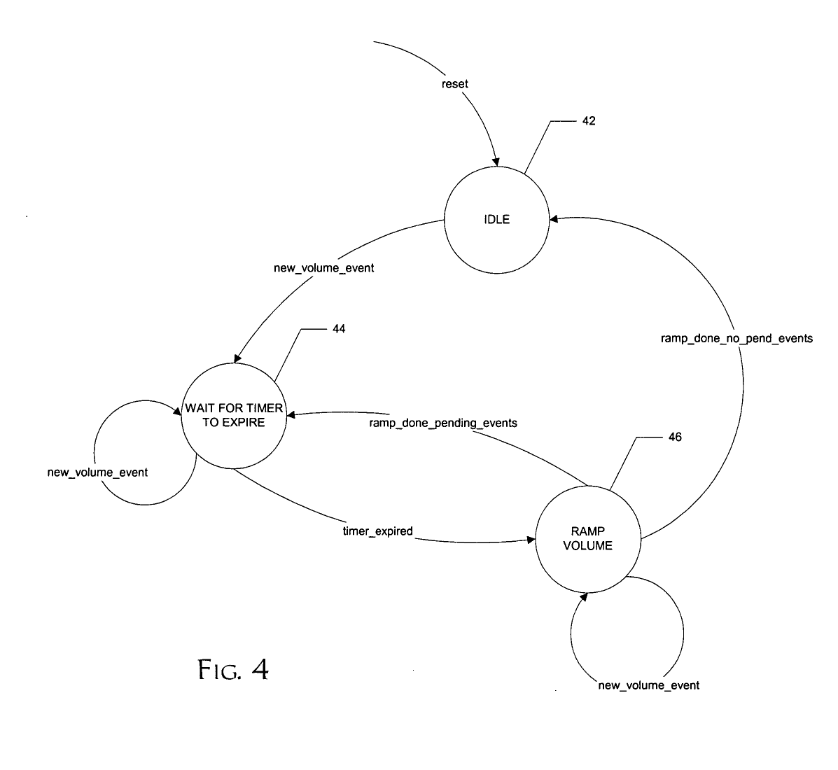

The operation of volume command processor 35 in responding to and processing volume control commands, according to the preferred embodiment of the invention, will now be described, with reference to the state diagram of FIG. 4. It is contemplated that the operations illustrated in this state diagram will be executed primarily by sequential logic 36, in conjunction with the other components of volume command processor 35. Of course, the particular details of operation can differ with the particular realization of system controller; for example, if volume command processor 35 is implemented by way of combinational logic or a conventional general purpose processor, this operation will be arranged in a linear manner, as will be recognized by those skilled in the art having reference to this description.

In this example, the operation begins with a reset operation, which places sequential logic into IDLE state 42. Sequential logic 36 remains in IDLE state 42 until a volume control command is presented by interface 34 in system controller 30 over serial digital interface CTRL_CH. This volume control command may be a global volume command in which all channels have their volume level changed, or may be a volume command directed to one or a subset of the available channels. Sequential logic 36, and thus volume command processor 35 itself, takes no action toward changing the audio output volume, but instead simply stores an indication of the volume level communicated by the command in the appropriate one or more of registers 49 for the affected channels. Also in response to this volume control command, sequential logic 36 resets and starts timer 38 to begin counting or otherwise measuring its selected time duration, or interval, and effects the sequential logic event new_volume_event shown in FIG. 4. Sequential logic 36 thus makes a transition to WAIT state 44.

According to the preferred embodiment of the invention, sequential logic 36 remains in WAIT state 44 until the interval of timer 38 expires. However, if interface 34 receives a new volume command (new_volume_event of FIG. 4), sequential logic 36 resets and restarts timer 38, and remains in WAIT state 44. Each additional volume control commands received before the elapse of the interval at timer 38, will cause an instance of the new_volume_event, and will cause sequential logic 36 to reset and restart timer 38.

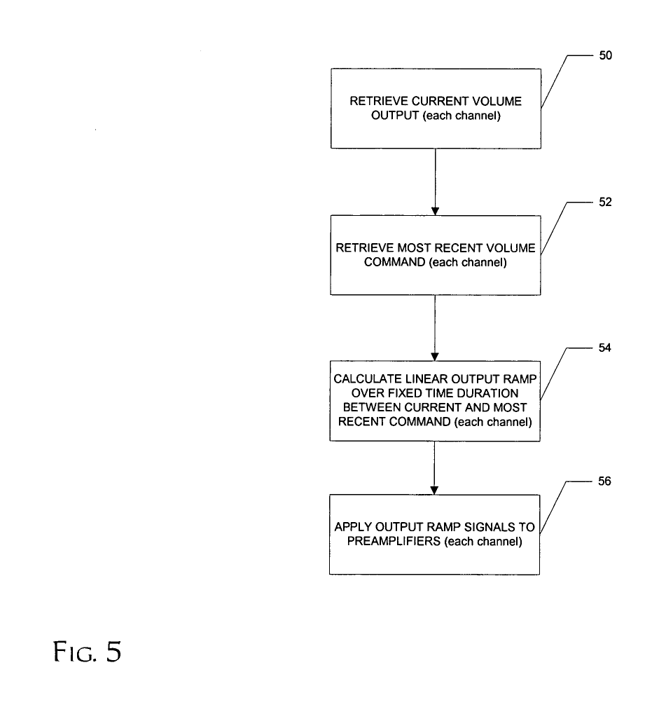

Upon the interval of timer 38 elapsing, with no new volume control command being received, sequential logic 36 makes a transition to RAMP VOLUME state 46 (via event timer_expired as shown in FIG. 4). In state 46, sequential logic 36 forward control signals to preamplifier control processor 32 to derive and apply ramping volume commands to the appropriate circuitry within PWM audio processor 20 (FIG. 2), typically to preamplifiers 21 as shown in FIG. 3. Referring now to FIG. 5, the operation of preamplifier control processor 32 to apply this ramping volume control commands, or signals, according to the preferred embodiment of the invention will now be described.

In process 50, preamplifier control processor 32 retrieves the current volume output level for each channel, for example by way of the current volume signal level generated by preamplifier control processor 32 to PWM audio processor 20. In process 52, preamplifier control processor 32 retrieves the most recent volume command for each channel from registers 49. This most recent volume command is the volume level most recently received, before the elapse of the interval measured by timer 38. As such, upon completion of process 52, preamplifier control processor 32 has available the current volume output and the most recent volume command for each channel. In effect, therefore, preamplifier control processor 32 performs “batch” processing of the volume commands that have been received from the first volume command that caused the initial starting of timer 38 through the most recent volume command that preceded the completed interval, as measured by timer 38, resulting in the current transition of sequential logic 36 to RAMP VOLUME state 46.

In process 54 according to this embodiment of the invention, preamplifier control processor 32 calculates a linear output ramp for the output volume control signal to be applied to each channel. According to one embodiment of the invention, a fixed ramp time duration is programmed into preamplifier control processor 32. This fixed ramp time duration is the time over which the output volume control signal is to be ramped from its current level to the desired level indicated by the most recently received volume command retrieved in process 52. It is contemplated that a typical fixed ramp time duration may be on the order of 30 to 90 msec, although of course the particular length of time can vary according to the particular implementation and desired performance.

Alternatively, the ramping of the output volume control signal need not be a linear ramping of volume over a fixed duration. According to another embodiment of the invention, it is contemplated that the volume can be changed in a proportional manner, for example at a selected rate of change in decibels per millisecond over a proportional time duration, i.e. with the time duration proportional to the magnitude of the desired volume change from the current volume level to the desired volume level. It is contemplated that these and other ramping approaches for changes in volume will be apparent to those skilled in the art having reference to this specification.

In any case, as a result of process 54, a ramp profile of the output volume control signal will be derived for each of the channels; considering that the different channels may have received different volume commands, or were originally at different volume levels, the ramp profile can vary from channel to channel. Indeed, in connection with a balance operation, it is contemplated that one channel may have an increasing volume while others may have a decreasing volume, over the same interval.

In process 56, preamplifier control processor 32 applies the ramping output volume control commands to preamplifiers 21, or to other circuitry, elsewhere within PWM audio processor 20. In this regard, it is contemplated that preamplifier control processor 32 itself will generate the ramping output commands. Alternatively, it is contemplated that digital logic or analog circuitry may be provided in PWM audio processor 20 between preamplifier control processor 35 and preamplifiers 21 to effect the desired volume ramp operation by interpreting a sequence of control signals (e.g., a data stream of changing digital values) from preamplifier control processor 35 and controlling the output volume accordingly.

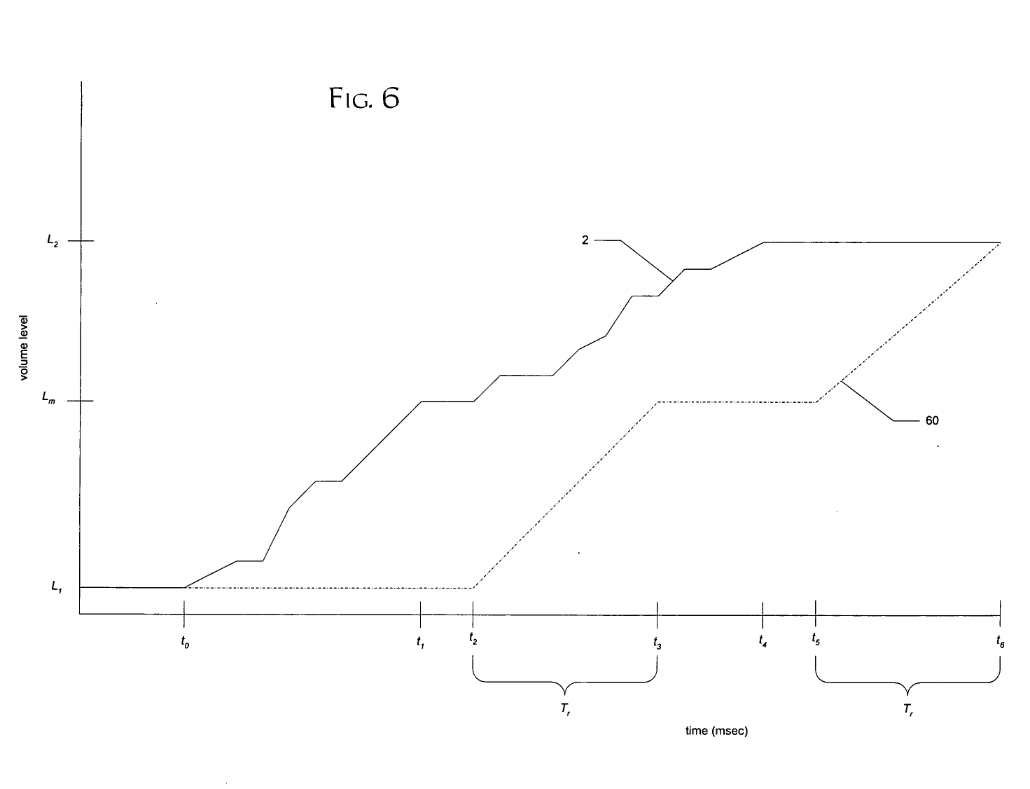

While sequential logic 36 is in RAMP VOLUME state 46, during which preamplifier control processor 32 performs the process of FIG. 6, new volume commands may be received by interface 34 and forwarded to volume command processor 35 over interface CTRL_CH. If so, each new volume event is stored, for each channel, in the corresponding registers 49. But sequential logic 36 remains in RAMP VOLUME state 46 until preamplifier control processor 32 has completed the ramping of the output volume, over the fixed or proportional ramp time duration described above.

Upon completion of the ramped volume, sequential logic 36 exits RAMP VOLUME state 46. If no new volume command has been received (i.e., is pending) from system controller 30 in the meanwhile, sequential logic 36 returns to IDLE state 42 to await the next volume command. The volume control operation of sequential logic 36 then continues as described above. If a new volume command was forwarded by interface 34 in system controller 30 over interface CTRL_CH before the volume ramp operation was completed by preamplifier control processor 32, the pending events will cause sequential logic 36 to make a transition to WAIT state 44, at which point it again resets and restarts timer 38 as before, where sequential logic 36 remains until the timer 38 interval elapses with no new volume command, effecting again the transition to RAMP VOLUME state 46, with the resulting ramped volume control as described above.

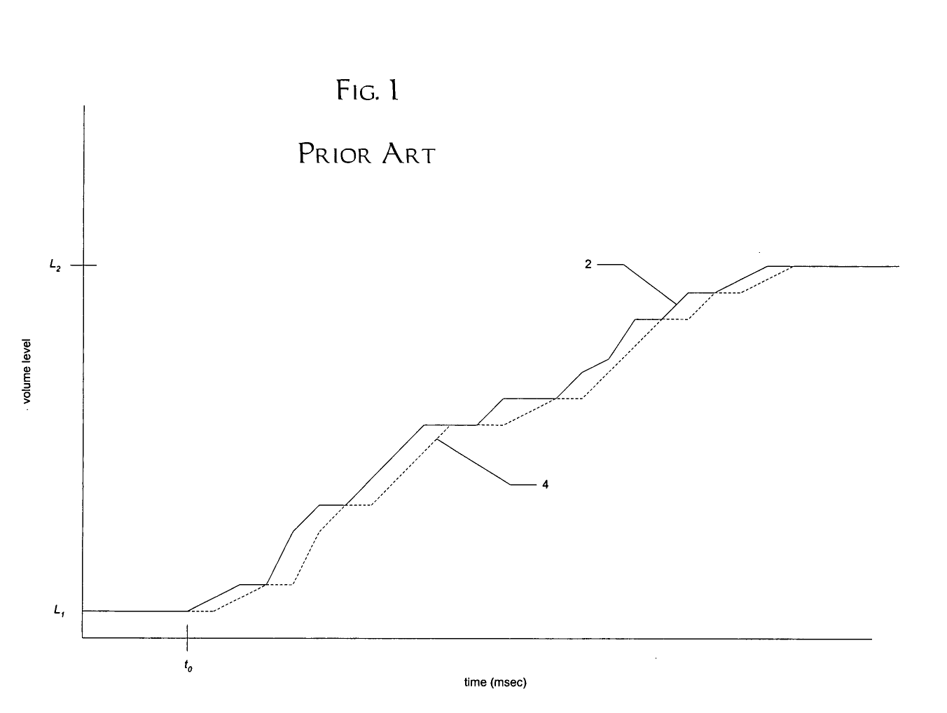

Referring now to FIG. 6, an example of the operation of this preferred embodiment of the invention in providing a smooth, and artifact-free, volume transition will now be described. Plot 2 of the input volume commands, following the example of FIG. 1 is replicated in FIG. 6; and plot 60 illustrates the output volume level signals generated by system controller 30 according to the preferred embodiment of the invention, in response to the input commands of plot 2.

As previously described relative to FIG. 1, receiver 10 is at a steady state volume level L₁ prior to time t₀. At time t₀, user volume increase commands are received by receiver 10 by way of front panel 25, or infrared transmitter 27 as the case may be. Referring back to FIG. 4, this command causes sequential logic 36 to enter WAIT state 44, to store the incoming volume command in the appropriate register 49, and to start timer 38. In the example of FIG. 6, timer 38 is continuously reset and restarted from time t₀ to t₁, during which time sequential logic 36 remains in WAIT state 44; volume command processor 35 thus maintains the original output volume level L₁ during this time. To the extent that constant input volume levels are presented prior to time t₁ in this example, the duration of these constant input levels is too short to permit timer 38 to elapse its interval (e.g., 5 msec). At time t₁, the input volume level begins to remain constant, and at time t₂ in this example, timer 38 reaches the end of its interval after the receipt of the most recent volume command at time t₁. Therefore, beginning at time t₁, sequential logic 36 then makes the transition to RAMP VOLUME state 46, and preamplifier control processor 32 calculates the desired volume ramp increase based on the most recent volume input command, which was at volume level Lₘ at time t₁. The output volume thus begins increasing along this calculated linear ramp, as shown in plot 60 of FIG. 6, toward the output volume level Lₘ, over a fixed ramp duration Tᵣ. The rate of change of the volume output is determined by the difference between current volume level L₁ and the most recent volume command level Lₘ, and the fixed ramp duration Tᵣ. Accordingly, the output volume level reaches level Lₘ at time t₃, where time t₃ is at a time Tᵣ after time t₂.

During the ramping of the output volume between time t₂ and time t₃, additional volume commands were received, as evident from plot 2. According to the preferred embodiment of the invention, as described above relative to FIG. 4, these pending events that occurred between time t₂ and time t₃ were successively stored in registers 49, and cause sequential logic 36 to transition to WAIT state 44 at time t₃. Because additional input volume commands continue to be received after time t₃, timer 38 is again reset and restarted by sequential logic 36, and the output volume level remains constant after time t₃. Once the input volume command reaches its eventual desired volume level L₂ at time t₄, however, timer 38 begins to run and, at time t₅, reaches the end of its selected interval. This again causes sequential logic 36 to transition to RAMP VOLUME state 46, causing the output volume to again ramp toward the level of the most recent input command, which is at the final volume level L₂ in this example. The rate of change of the output volume is again recalculated, as described above, from the current volume level Lₘ at time t₄ and the most recent input volume command level L₂ at time t₄. The duration of the volume ramp remains fixed at time Tᵣ, as discussed above. Accordingly, after time t₅, system controller 30 ramps the output volume level from current volume level Lₘ to output volume level L₂. It is contemplated that the rate of change of the output volume will differ over time, as in this case, because the ramp time duration Tᵣ is fixed while the difference between the current volume and most recent volume command levels will often differ. Eventually, the output volume reaches the final volume level L₂, at time t₆ in this example.

It is understood that, as shown in FIG. 6, the volume control of this preferred embodiment of the invention will delay the eventual reaching of the desired volume level. However, it is contemplated that this delay will not be noticeable to the human user, considering that it is contemplated that the processing involved in the volume control according to this invention can be accomplished in a matter of milliseconds by modern circuit technology. But because the generation of audible artifacts occurring in change of volume is greatly reduced according to this invention, it is contemplated that this invention will provide much more pleasing sound from receiver 10 as volume changes are effected by the user. It is therefore contemplated that this invention will provide advantages that are significant, in both the audible and commercial sense, over conventional digital audio receiver circuitry.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A digital audio receiver, comprising:
a digital audio processor for receiving a datastream corresponding to an audio signal, and for generating a first output signal corresponding to a first audio channel;
a user input interface, for receiving volume commands;
a system controller for receiving volume commands from the user input interface; and
a volume command processor, coupled to the digital audio processor and to the system controller, for controlling the digital audio processor to generate the first output signal at a selected volume level, comprising:
a timer, for measuring a selected time duration; and
volume control circuitry, coupled to the system controller and the timer, for issuing a ramping volume level control signal responsive to the timer measuring the selected time duration during which no additional volume command is received at the interface.

2. The receiver of claim 1, wherein the volume control circuitry is also for resetting the timer to restart its measuring of the selected time duration responsive to the interface receiving a volume command.

3. The receiver of claim 2, wherein the volume control circuitry further comprises:
circuitry for calculating the ramping volume level control signal responsive to a current volume level, a volume level of a most recently received volume command, and a fixed ramp time duration.

4. The receiver of claim 3, wherein the calculating circuitry calculates the ramping volume level control signal responsive to the timer measuring the selected time duration during which no additional volume command is received at the interface.

5. The receiver of claim 2, wherein the volume control circuitry further comprises:
circuitry for calculating the ramping volume level control signal responsive to a current volume level, a volume level of a most recently received volume command, and a proportional ramp time duration.

6. The receiver of claim 5, wherein the calculating circuitry calculates the ramping volume level control signal responsive to the timer measuring the selected time duration during which no additional volume command is received at the interface.

7. The receiver of claim 1, wherein the digital audio processor generates a plurality of output signals, each corresponding to one of a plurality of audio channels.

8. The receiver of claim 7, wherein the volume control circuitry is also for resetting the timer to restart its measuring of the selected time duration responsive to the interface receiving a volume command associated with any of the plurality of audio channels.

9. The receiver of claim 8, wherein the volume control circuitry is for issuing a ramping volume level control signal responsive to the timer measuring the selected time duration during which no additional volume command is received at the interface for any of the plurality of audio channels.

10. The receiver of claim 1, further comprising:
a digital audio decoder circuit, having an output coupled to provide the datastream to the digital audio processor;
a multiplexer, having a plurality of inputs for coupling to a respective plurality of audio sources, and having a control input for receiving a control signal from the system controller and selecting one of the plurality of inputs in response thereto.

11. The receiver of claim 1, wherein the digital audio processor generates a first pulse-width-modulated output signal corresponding to the first audio channel.

12. The receiver of claim 1, wherein the digital audio processor comprises a preamplifier, the preamplifier having an input for receiving the first output signal.

13. A method of controlling the volume in a digital audio system, comprising:
responsive to receiving an audio volume command, initiating a timer to measure a selected time interval;
responsive to receiving another audio volume command, restarting the timer;
responsive to the timer measuring the selected time interval, generating a volume ramp control signal responsive to a most recently received audio volume command; and
applying the volume ramp control signal to a digital audio processor.

14. The method of claim 13, further comprising:
storing a digital value corresponding to each received audio volume command;
wherein the step of generating the volume ramp control signal generates the volume ramp control signal responsive to a current volume level, the stored digital value corresponding to the most recently received audio volume command, over a selected time duration.

15. The method of claim 14, wherein the selected time duration is a fixed time duration.

16. The method of claim 14, wherein the selected time duration is proportional to a difference between the current volume level and the stored digital value.

17. The method of claim 14, further comprising:
responsive to receiving another audio volume command, discarding the stored digital value corresponding to a previously received audio volume command.

18. The method of claim 14, further comprising:
responsive to receiving another audio volume command during the step of generating the volume ramp control signal, storing a digital value corresponding to the another audio volume command; and
then, after the step of generating the volume ramp control signal, restarting the timer.

19. The method of claim 14, further comprising:
responsive to receiving another audio volume command, after the step of generating the volume ramp control signal, storing a digital value corresponding to the another audio volume command; and
repeating the restarting, generating, and applying steps.

20. The method of claim 13, wherein the digital audio system generates audio output signals for a plurality of channels;
wherein the step of initiating the timer is performed responsive to receiving an audio volume command associated with any of the plurality of channels;
and wherein the step of restarting the timer is performed responsive to receiving another audio volume command associated with any of the plurality of channels.

21. The method of claim 20, wherein the step of generating a volume ramp control signal comprises, for each of the plurality of channels;
generating the volume ramp control signal responsive to a current volume level for the channel relative to the stored digital value corresponding to the most recently received audio volume command for the channel, over the selected time duration;
and wherein the applying step applies the generated volume ramp control signal to the audio amplifier for each of the plurality of channels.
